(19) United States
(12) Patent Application Publication
(10) Pub. No.: US 2026/0049421 A1
(43) Pub. Date: Feb. 19, 2026

(54) PLASTIC HEALDS WITH MULTIPLE EYES

(71) Applicant: SHAH PLASTOTECH LLC, Palm Beach Gardens, FL (US)

(72) Inventors: Ashok Khumchand Shah, Mumbai (IN); Asha Ashok Shah, Mumbai (IN); Nirav Ashok Shah, Surat (IN)

(21) Appl. No.: 19/295,263

(22) Filed: Aug. 8, 2025

(30) Foreign Application Priority Data
Aug. 8, 2024 (IN) 202421060008

(51) Int. Cl. D03C 9/02; C08K 3/30; C08K 3/34; C08L 59/00

(52) U.S. Cl. CPC D03C 9/026; C08K 3/30; C08K 3/34; C08L 59/00; D03C 9/024; C08K 2003/3009; C08K 2003/343; C08L 2205/025

(57) ABSTRACT

The present invention provides a heald suitable for use with various types of weaving looms. The heald is constructed from plastics having two distinct colors which meet around the middle of the heald so that each color includes an eye for guiding the warp threads. The edges and sides of the heald are arced and radiused to reduce friction from passing up and down through the yarns to allow for faster machine operation. In some embodiments, the top end of the heald is constructed and arranged to grip the operational cords typically used on a Jacquard weaving machine. The grip end of the heald includes a sinusoidal path and alligator like teeth to prevent slipping of the cords.

### PRIORITY CLAIM

In accordance with 37 C.F.R. 1.76, a claim of priority is included in an Application Data Sheet filed concurrently herewith. Accordingly, the present invention claims the benefit of the priority of Indian Provisional Patent Application No. 202421060008, entitled “PLASTIC HEALDS WITH MULTIPLE EYES”, filed on Aug. 8, 2024; the contents of which is incorporated herein by reference.

### FIELD OF THE INVENTION

The present invention relates to plastic healds and more particularly to plastic healds with multiple eyes.

### BACKGROUND OF THE INVENTION

Healds, also known as Heddles, are an essential component of looms used in fabric weaving. They allow weavers to construct complex patterns and designs by accurately controlling the warp threads. Proper maintenance and selection of healds is necessary to ensure the effectiveness and quality of the weaving process.

A typical heald is made from metal or synthetic material and consists of a thin wire or flat strip with an eye (hole) in the center. The thread or yarn is passed through the heald's eye, which is fastened to the loom's harnesses during the weaving process. By raising and lowering the harnesses, the healds move the warp threads up and down, producing an opening through which the weft thread is transferred to produce the fabric.

Traditional healds come in various types, including wire healds for fine fabrics, flat steel healds for durability, and synthetic healds for specific weaving: needs. They are typically made of metal or plastic and are suspended on a loom's shafting to move in a repeating motion. These healds often suffer from significant wear-and-tear to the point of failure under the high-speed mechanical stress of high-volume weaving operations. The eye, where the warp thread passes through, is mostly prone to wear and breakage, causing frequent disruptions and increased maintenance, mostly due to friction generated between the threads and the heald(s). Moreover, the continuous contact between the warp threads and the healds causes friction and damage to both the heald and the fabric, affecting fabric quality. Additionally, metal healds are heavier than polymeric healds, adding weight to the loom's moving parts, which reduces weaving speed and efficiency. Also, the added weight from the metal healds increases high-speed impact during operation (up to 600-1000 times per minute), increasing maintenance costs and reducing the life of the machinery.

Traditional healds often bend, deform or break under tension, leading to uneven fabric and process disruptions. Frequent maintenance and replacements are needed due to wear, breakages, and corrosion, increasing operational costs and downtime. They are often incompatible with advanced, high-speed, or computerized looms, limiting their use in modern textile manufacturing. Variations and inconsistencies in manufacturing healds lead to inconsistent quality, affecting fabric uniformity.

Another shortcoming of modern healds results from low cost manufacturing of inferior materials that increase friction and heat generation. Still another shortcoming results from poor heald geometry, which also results in increased friction, wear and heat generation.

Still another shortcoming in the prior art is a heald that utilizes two plastics of two colors that meet in the middle of the heald to increase visibility of the heald movement while in operation.

Still yet another shortcoming in the prior art is that a heald constructed from two plastics having two colors wherein each plastic has different properties with respect to the other is not disclosed.

Still a further shortcoming is that the prior art fails to teach or suggest a heald that includes elongated radiused side surfaces to reduce friction and increase machine operational speed.

Still yet a further shortcoming in the prior art is a heald having at least one eye wherein the at least one eye includes multiple layers of friction rails which reduce contact area between the thread and the heald as it passes through the eye.

### DESCRIPTION OF THE PRIOR ART

Chinese Patent Application No. CN211339842U to Wang Hongliang discloses a steel wire heald having a heald eye, at least two rod bodies connected to the heald eye, heald lugs arranged at the free ends of the rod bodies and ceramic washers arranged in the heald eye and provided with eyelets. However, because of the mechanical strain they experience during weaving, these steel wire healds are heavy, causing the looms wear-and-tear, they are also expensive and noisy when in use.

Netherlands Patent Application No. NL8200107A to Louet Beheer B.V. discloses a plastic heald for a manually operated weaving loom. The heald is constructed from a single color and type of plastic to include a single eye for passing the warp thread, an opening to fit on the heald shaft above it and a downward projection. However, this plastic heald includes flat side surfaces that may cause increased friction with warp threads, potentially leading to thread damage. Also, the eye may undergo breakage due to friction with warp threads and is also not suitable with all types of looms.

Thus, what is needed in the art is a heald that utilizes two plastics of two colors that meet in the middle of the heald to increase visibility of the heald movement while in operation. What is also needed is a heald constructed from two plastics having two colors, wherein each plastic has different properties with respect to the other. Another need in the art is a heald that includes radiused side surfaces to reduce friction and increase machine operational speed. Still yet, what is needed in the art is a heald having at least one eye wherein the at least one eye includes multiple layers of friction rails which reduce contact area between the thread and the heald.

Therefore, the present device provides a heald that includes at least two plastics; the plastics being a different color and, in some cases, having different properties when compared to the other plastic used to form the heald. At least one eye extends through each plastic, giving each eye a different characteristic for use. The present device also rounds the edges and sides of the heald to reduce friction from passing up and down through the yarns to allow for faster machine operation. Still yet, in some embodiments a first end of the heald is constructed and arranged to grip the operational cords typically used on a Jacquard weaving machine.

### SUMMARY OF THE INVENTION

The present invention provides a heald suitable for use with various types of weaving looms. The heald is constructed from plastics having two distinct colors which meet around the middle of the heald so that each color includes an eye for guiding the warp threads. The edges and sides of the heald are arced and radiused to reduce friction from passing up and down through the yarns to allow for faster machine operation. In some embodiments, the top end of the heald is constructed and arranged to grip the operational cords typically used on a Jacquard weaving machine. The grip end of the heald includes a sinusoidal path and alligator like teeth to prevent slipping of the cords.

Therefore, it is an objective of the present invention to provide a heald that includes two plastics, wherein each eye is constructed of only one of the plastics.

It is another objective of the present invention to cause the two plastics to meet in the middle portion of the heald to provide for visibility during use, as well as eye construction.

It is a still further objective of the present invention to provide a heald having arcuate side surfaces for reducing friction with adjacent yarns.

It is yet another objective of the present invention to provide a heald wherein the eye(s) includes multiple layers of friction rails which reduce contact area between the yarn and the heald.

It is still yet another objective of the present invention to provide a heald having a twisted eye portion for reducing friction.

Still yet another objective of the present invention is to provide a heald for a Jacquard weaving machine that includes a sinusoidal path and alligator like teeth to prevent slipping of the cords at the grip end of the heald.

Yet another objective of the present invention is to provide a heald that includes additives in the plastic to reduce harmonics from the rubbing yarn and block heat transfer through the heald.

Other objects and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE FIGURES

The patent or application file contains at least one drawing executed in color. Copies of this patent or patent application publication with color drawing(s) will be provided by the Office upon request and payment of the necessary fee.

The objectives and advantages of the present invention will become apparent from the following description read in accordance with the accompanying drawings wherein,

FIG. 1 is a side view of flat healds illustrating two eyes and various end attachment grips in accordance with the present invention;

FIG. 2 is a front view of a Jacquard heald employing the teachings of the present application;

FIG. 3 is a side by side view of a flat heald and a Jacquard heald illustrating the two color plastics;

FIG. 4 is a perspective view of a complete Jacquard heald assembly;

FIG. 5 is a partial view taken along lines 5-5 of FIG. 4 illustrating the leg pin and spring of the Jacquard heald assembly;

FIG. 6 is a partial view taken along lines 6-6 of FIG. 4 illustrating the cord clamp assemblies of the Jacquard heald assembly;

FIG. 7 is a partial front view taken along lines 7-7 of FIG. 2 illustrating the cord clamp;

FIG. 8 is a partial front view taken along lines 8-8 of FIG. 2 illustrating the spring attachment post for the Jacquard heald;

FIG. 9 is a partial front view of the eye block of the Jacquard heald taken along lines 9-9 of FIG. 2;

FIG. 10 is a partial section view taken along lines 10-10 of FIG. 9 illustrating the friction rails;

FIG. 11 is a side view of the flat heald illustrating the two plastic construction;

FIG. 12 is a partial side view of the flat heald taken along lines 12-12 of FIG. 11;

FIG. 13 is a partial perspective view of the flat heald illustrating the turned eyes;

FIG. 14 is a front view of the flat heald illustrating the turned eyes; and

FIG. 15 is a section view taken along lines 15-15 of FIG. 12 illustrating the oval shape of the first and second legs.

### DETAILED DESCRIPTION OF THE INVENTION

References in the specification to “one embodiment” or “an embodiment” means that a particular feature, structure, characteristic, or function described in connection with the embodiment is included in at least one embodiment of the invention. The appearances of the phrase “in one embodiment” in various places in the specification are not necessarily all referring to the same embodiment.

The foregoing description of specific embodiments of the present invention has been presented for purposes of illustration and description. They are not intended to be exhaustive or to limit the present invention to the precise forms disclosed and obviously many modifications and variations are possible in light of the above teaching.

In the textile manufacturing industry, a heald typically lifts and lowers the warp threads to create the necessary shed for weaving. The heald thus controls the movement of the warp thread in a loom during textile manufacturing. The present invention relates to a plastic heald having more than one eye employed in the looms for textile manufacturing.

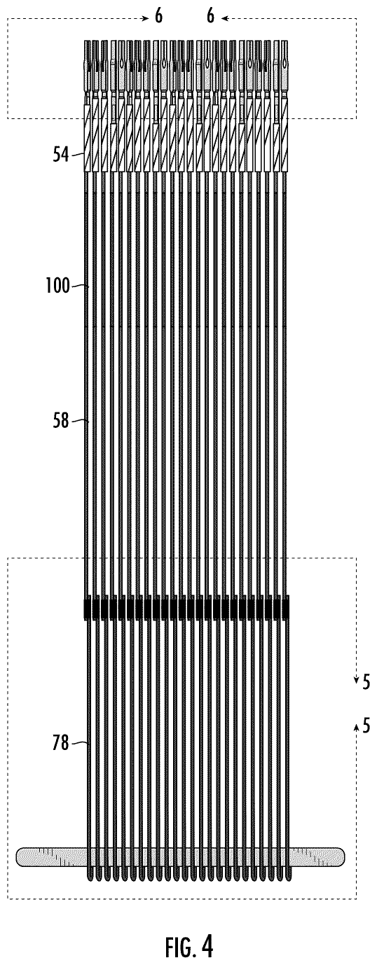

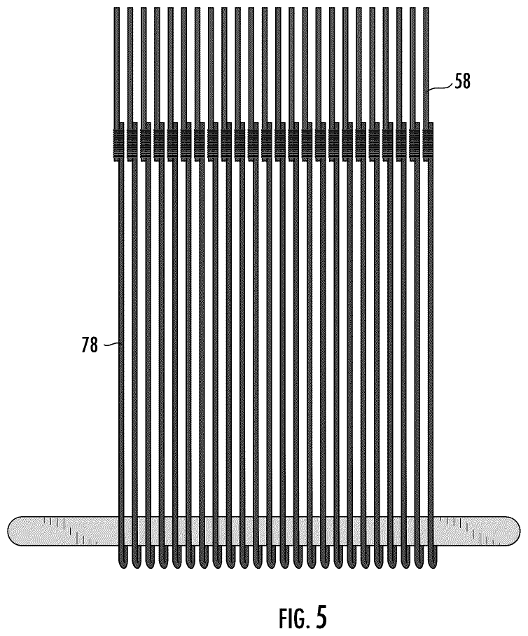

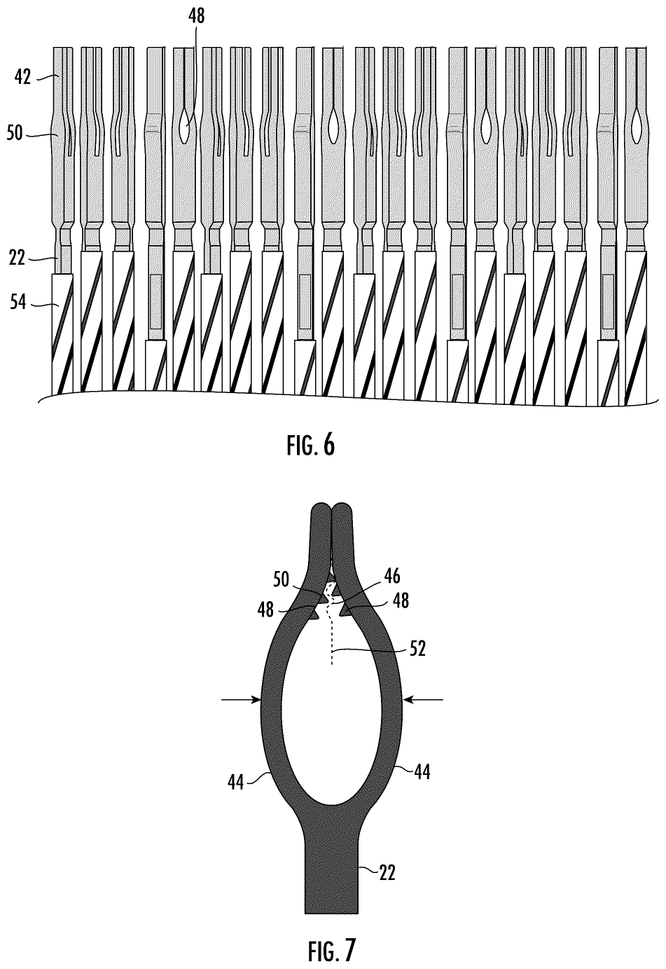

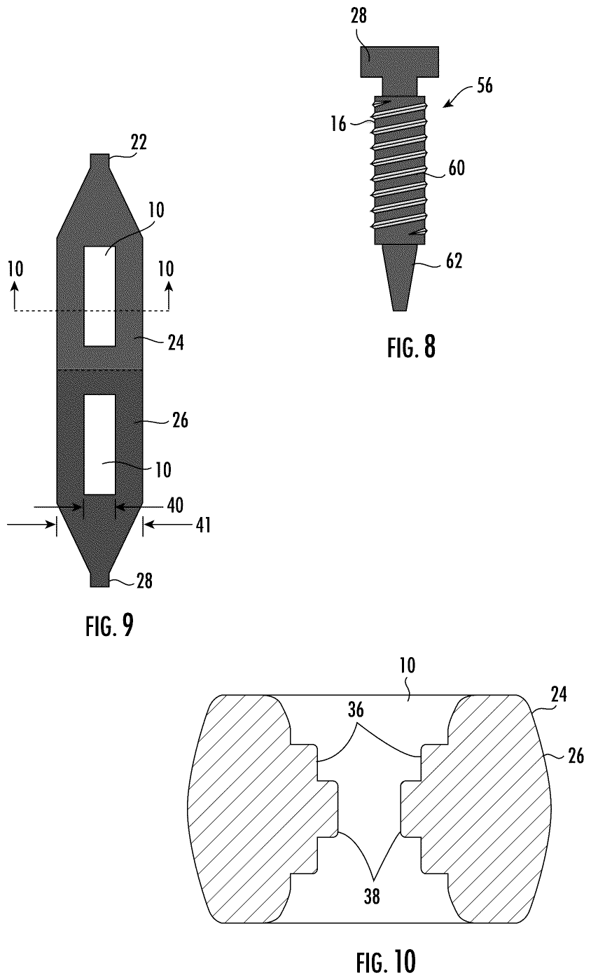

Referring generally to FIGS. 1-15, a heald 100 for a weaving machine is illustrated. The heald includes a first end 14 including a first end attachment 18 for securing the first end 14 of the heald 100 to the weaving machine to provide an upward motion, a first leg 22 extending to a central portion of the heald and being formed integral to a first eyebox 24 including at least one eye 10. A second end 16 of the heald 100 includes a second end attachment 20 for providing a downward return motion of the heald 100, a second leg 28 also extending to a central portion of the heald and being formed to a second eyebox 26 so that the eyeboxes 24, 26 are adjacent with respect to each other. In the preferred embodiment, the first end 14, the first leg 22 and the first eyebox 24 are constructed from a first plastic material 30, while the second end 16, the second leg 28, and the second eyebox 26 are constructed from a second plastic material 32. In a most preferred embodiment, the first plastic material 30 and the second plastic material 32 have different physical properties when compared to each other. While both ends are formed from contrasting colors, there may be additional differences in the materials. In some examples, the first plastic material 30 may be all virgin material, while the second material 32 may include up to 30% recycled plastic. In another example, one of the plastics may include insulators 34, reinforcing fibers, or friction reducers; some examples include mica, Kevlar, molybdenum disulfide, PTFE, carbon fibers or the like. The insulators reduce heat transfer from the friction of the rubbing yarns to the healds. In at least one embodiment, one of the plastic materials comprises Delrin and acetal copolymer or homopolymer. Other embodiments may utilize nylon 66 plastic. The differences in materials allow one end of the heald to be stiffer than the other. Thus, the yarn could be extended through a soft eye to prevent damage to the yarn while benefitting from the stiffness of the second plastic to keep the heald better positioned for operation.

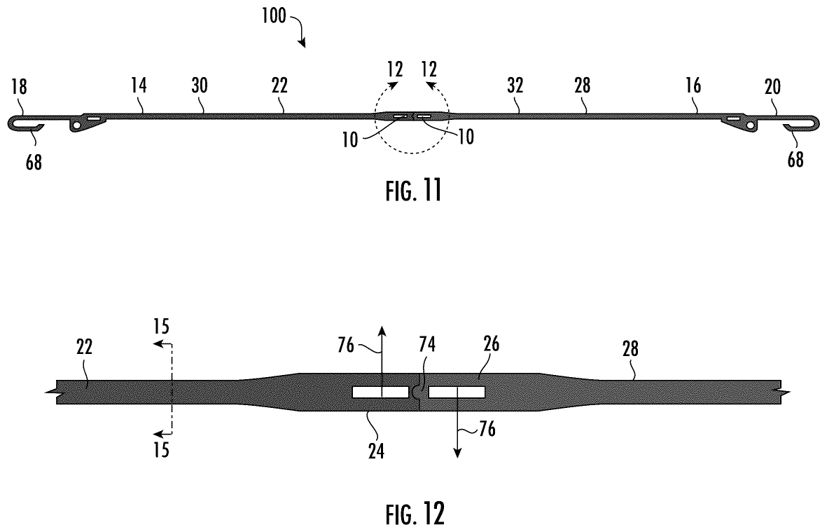

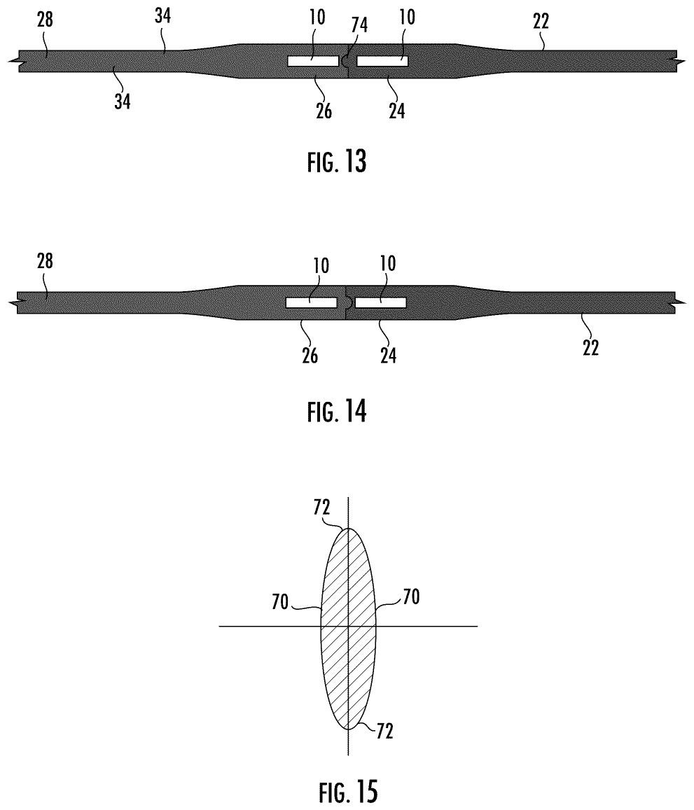

The first and second eyeboxes 24, 26, respectively, each surround and orient an eye 10 for guiding the yarn through the heald and allowing the heald to lift the yarn as required for weaving. In one embodiment the first eyebox 24 and eye 10 are rotated with respect to the second eyebox 26 and eye 10, see FIGS. 11-14. In this embodiment, the eye 10 in the first eyebox 24 is rotated in an opposite direction as the eye 10 in the second eyebox 26. This construction allows the heald to be positioned in the machine with the narrow side facing forward and the yarn passing through the eye(s) to allow very narrow spacing between the healds. FIG. 14 illustrates the heald in the edge orientation and the openings through the eyes visible, while FIGS. 12 and 13 illustrate the heald in a side orientation showing the two opposite angles of the eyes.

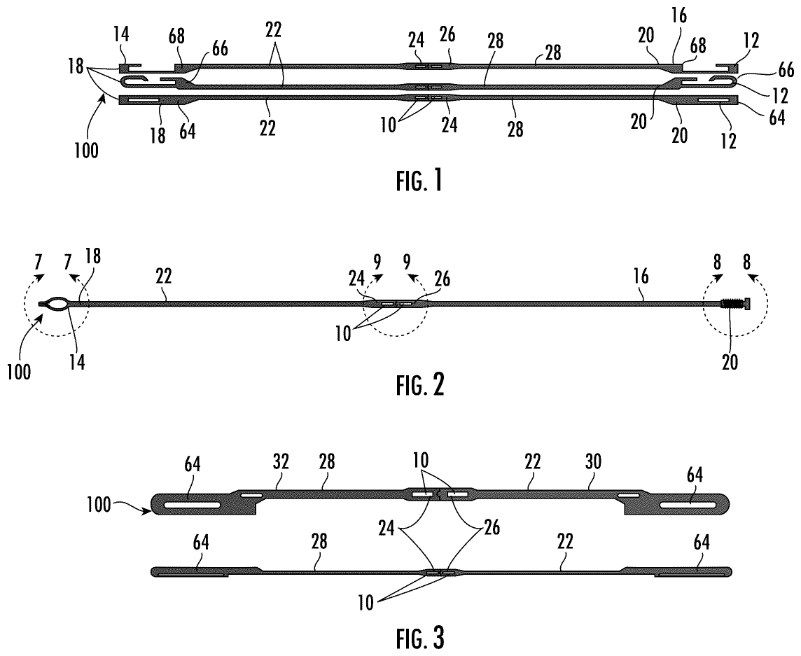

Still referring generally to the figures and more specifically to FIGS. 2, 4, and 7-10, a heald specifically built for a Jacquard machine is illustrated. In this embodiment, the eye 10 is typically much thicker than those used for other types of machines. Therefore, in the preferred embodiment of the present device, each eye 10 includes a first friction rail 36 extending inwardly toward a center of the eye 10, the friction rail 36 reducing the friction generated by yarn rubbing against the heald when compared to the prior art. In some embodiments, each eye 10 includes a second friction rail 38 extending inwardly around the inner perimeter of the first friction rail 36, the second friction rail 38 further reducing the contact between a yarn passing through the eye 10 and the heald to reduce friction and heat. It should be noted that the eye width 40 has a maximum of 1.5 millimeters and in some embodiments 1.0 millimeters or even as small as 0.8 millimeters in diameter. The eyeboxes 24, 26 reduce the eyebox width 41 of the eyebox to 2.7 millimeters or less, and a most-preferred embodiment reduces the eyebox width to less than 2.5 millimeters. This construction allows tighter control over the yarns as they pass through the heald while still limiting the friction and heat generation that typically comes from trying to closer control the yarns.

In some embodiments of the heald 100 for Jacquard, the first end attachment 14 includes a cord clamp 42; the cord clamp constructed and arranged to grip a pull cord on a Jacquard weaving machine. In the preferred embodiment, the cord clamp 42 includes a pair of opposing jaws 44 which include a narrowed section 46 wherein the inner walls 48 include a plurality of teeth 50 arranged to create a tortuous path 52 for the pull cord, the opposing jaws 44 compressed inward by a clamp straw 54 to close the narrowed section to clamp the pull cord. The clamp straw 54 is preferably constructed of at least three plastic materials extruded in a spiral pattern and attached to each other along the edges thereof to prevent curling of the clamp straw 54; each of the three plastic materials having distinctive properties with respect to the others. In a preferred embodiment, the plastic used to form the straw includes at least 10% high density plastic, 55% low density plastic and 35% linear low density plastic. This construction has been found to reduce the curling of the straws as they are formed to less than 3 degrees of curvature and in some case less than 2 degrees or even less than one degree of curvature along the length of the straw. In this manner, the inner diameter of the straw 54 is pulled over the outer surfaces of the opposing jaws 44 to compress the opposing jaws, closing the tortuous path 52 and clamping a cord used to operate the heald. A second end attachment 16 may include a spring bolt 56; the spring bolt 56 constructed and arranged to cooperate with a return spring in a Jacquard weaving machine. Thus, the spring bolt 56 includes a size similar to that of the inner diameter of a return spring 58 with helical threads 60 or the like suitable to rotate into engagement with the return spring 58. A pilot 62 may be provided to guide the helical threads into position for engagement with the spring. A leg pin 78 is secured to the distal end of the return spring 58 and is attached to the weaving machine at an opposite end.

Still referring generally to the figures, and more specifically to FIGS. 1, 3, and 11-15, an embodiment of the heald useful for a weaving machine is illustrated. In this embodiment, the first and second end attachments 18, 20 are typically loops 64, C-shaped 66, or J-shaped 68 for attachment to the weaving machine. The first and second legs 22, 28 preferably include an oval shape (FIG. 15) having two axes of symmetry when viewed in cross section. Alternatively, the cross section of the legs 22, 28 may be viewed to include a pair of opposing arcuate surfaces 70 connected at the distal ends with a radius 72 to minimize contact with passing and adjacently positioned yarns. In this embodiment, the first eyebox 24 and eye 10 is rotated with respect to the second eyebox 26 and eye 10, visible in FIGS. 12-14. The change in the angle of the eyebox occurs along a line 74 and is illustrated by the arrows 76 on FIG. 12. It should be noted that while the eye 10 is illustrated as being rectangular in shape, other shapes may be utilized without departing from the scope of the invention. Such shapes may include, but should not be limited to, oval, polygon, circular, irregular, keyhole, or the like. The eye 10 is positionable at various locations along the length of the heald 100, including the center, away from the center, the top side, or the bottom side of the heald 100. The spacing between the eyes 10 is variable depending on the requirement and is selected from less than 1.08 mm, equal to 1.08 mm, equal to 1.44 mm, equal to 1.8 mm, equal to 2.25 mm, greater than 2.25 mm or greater than 5 mm, accommodating diverse weaving needs.

The heald 100 in accordance with the preferred embodiment of the present invention enables handling different types of weaves and patterns. For example, a heald with multiple eyes facilitates the weaving of complex patterns and designs that require multiple threads to be manipulated simultaneously, crucial for creating intricate textiles. Further, the ability to space the eyes 10 according to specific requirements enables tailoring the heald 100 to the precise needs of the textile project, whether for decorative fabrics, technical textiles, or other specialized applications.

The plastic heald 100 in accordance with the preferred embodiment of the present invention is designed with two distinct colors for visual identification and functional differentiation.

The embodiments were chosen and described in order to best explain the principles of the present invention and its practical application, to thereby enable others skilled in the art to best utilize the present invention and various embodiments with various modifications as are suited to the particular use contemplated.

It is understood that various omission and substitutions of equivalents are contemplated as circumstances may suggest or render expedient, but such are intended to cover the application or implementation without departing from the scope of the present invention.

All patents and publications mentioned in this specification are indicative of the levels of those skilled in the art to which the invention pertains.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A heald (100) for a weaving machine comprising;
a first end (14) including a first end attachment (18) for securing the first end (14) of the heald (100) to the weaving machine to provide an upward motion,
a first leg (22) extending to a central portion of the heald and being formed integral to a first eyebox (24) including at least one eye (10), the first end (14), the first leg (22) and the first eyebox (24) being constructed from a first plastic material (30),
a second end (16) including a second end attachment (20) for providing a downward return motion of the heald (100),
a second leg (28) also extending to a central portion of the heald (100) and being formed to a second eyebox (26) including at least one eye (10), the second end (16), the second leg (28), and the second eyebox (26) being constructed from a second plastic material (32),
wherein the first plastic material (30) and the second plastic material (32) have different physical properties when compared to each other.

2. The heald (100) for a weaving machine as claimed in claim 1 wherein the first plastic material (30) forming the first end (14) or the second plastic material (32) forming the second end (16) includes a mixture of Delrin and acetyl copolymer.

3. The heald (100) for a weaving machine as claimed in claim 2 wherein the first plastic material (30) and/or the second plastic material (32) is formed from all virgin plastic material.

4. The heald (100) for a weaving machine as claimed in claim 1 wherein the first plastic material (30) forming the first end (14) or the second plastic material (32) forming the second end (16) includes an insulator material (34) dispersed throughout the plastic material to reduce heat transfer to the heald (100).

5. The heald (100) for a weaving machine as claimed in claim 4 wherein the insulator material is mica.

6. The heald (100) for a weaving machine as claimed in claim 4 wherein molybdenum disulphide is added to the plastic as a friction reducer.

7. The heald (100) for a weaving machine as claimed in claim 1 wherein the first and second eyeboxes (24) (26), respectively, each surround and orient an eye (10), each eye (10) including a first friction rail (36) extending inwardly toward a center of the eye (10), the friction rail (36) reducing the friction generated by yarn rubbing against the friction rail (36).

8. The heald (100) for a weaving machine as claimed in claim 7 wherein each eye (10) includes a second friction rail (38) extending inwardly around the inner perimeter of the first friction rail (36), the second friction rail (38) further reducing the contact between a yarn passing through the eye (10) and the heald (100) to reduce friction and heat.

9. The heald (100) for a weaving machine as claimed in claim 8 wherein the eye boxes (24) (26) have a width of a maximum of 2.5 millimeters.

10. The heald (100) for a weaving machine as claimed in claim 1 wherein the first end attachment (14) includes a cord clamp (42), the cord clamp (42) constructed and arranged to grip a pull cord on a Jacquard weaving machine.

11. The heald (100) for a weaving machine as claimed in claim 1 wherein the cord clamp (42) includes a pair of opposing jaws (44) which include a narrowed section (46) wherein the inner walls (48) include a plurality of teeth (50) arranged to create a tortuous path (52) for the pull cord, the opposing jaws (44) compressed inward by a clamp straw (54) to close the narrowed section to clamp the pull cord.

12. The heald (100) for a weaving machine as claimed in claim 11 wherein the clamp straw (54) is constructed of at least three plastic materials extruded in a spiral pattern and attached to each other along the edges thereof to prevent curling of the clamp straw (54), each of the three plastic materials having distinctive properties with respect to the others, wherein the plastics are at least 10% high density plastic, 55% low density plastic and 35% linear low density plastic.

13. The heald (100) for a weaving machine as claimed in claim 1 wherein the second end attachment (16) includes a spring bolt (56), the spring bolt (56) constructed and arranged to cooperate with a return spring (58) in a Jacquard weaving machine.

14. The heald (100) for a weaving machine as claimed in claim 1 wherein the first and second legs (22) (28) include an oval shape having two axes of symmetry when viewed in cross section.

15. The heald (100) for a weaving machine as claimed in claim 1 wherein the first eyebox (24) and eye (10) is rotated with respect to the second eyebox (26) and eye (10).
